(19) United States
(12) Patent Application Publication
(10) Pub. No.: US 2011/0062717 A1
(43) Pub. Date: Mar. 17, 2011

(54) Urility grid vertical axis wind turbine system

(76) Inventor: ARNOLD PRICE, JR., LOVELAND, CO (US)

(21) Appl. No.: 12/584,984

(22) Filed: Sep. 16, 2009

(51) Int. Cl. F03D 9/00; F03D 3/00

(52) U.S. Cl. 290/55

(57) ABSTRACT

A vertical axis wind system for generation and distribution of electrical energy to a utility grid is provided. The system includes a power pole electricity system supported by a plurality of ground-based upright support members. The electricity system is electrically connected to the utility grid. The support members include at least one vertical rotor shaft portion. The rotor shaft portion has an outer surface and a vertical axis of rotation. A vertical axis wind turbine is rotatably attached to the rotor shaft portion so that the wind turbine rotates freely around the outer surface of the rotor shaft portion. A power takeoff is coupled to the wind turbine for driving a generator electrically connected to the utility grid when exposed to an atmospheric wind condition.

### CROSS REFERENCE TO RELATED APPLICATIONS

This application is a national stage application which claims the benefit of International Application No. PCT/US2009/004413, filed 31 Jul. 2009.

### STATEMENT OF FEDERALLY SPONSORED RESEARCH

Not applicable.

### BACKGROUND OF THE INVENTION

1. Field of the Invention

The present invention relates to wind power and distribution. In particular, it relates to a vertical axis wind turbine system deployed on the power grid for converting energy extracted from atmospheric wind into electrical energy transmitted to the power grid.

2. Description of the Related Art

Vertical axis wind turbines are well known in the art for extracting energy from atmospheric wind, and converting that energy, into electrical energy. Wind power turbines have been shown to be capable of generating power for delivery, via interconnection, to existing grid systems, individual homes, businesses, or utilities. Most of all of the wind power systems are designed to gather large amounts of power, in the Mega Watt range, through the deployment of enormous wind turbines, which are typically at least 100 feet high. Small wind powered turbines have also been deployed, and are configured to power a single home, business, or certain elements of a home or business.

In large wind installations, in the magnitude of 100 foot or more, giant sized turbines often dot the landscape and compromise the environment. Such large turbines are typically deployed in remote areas, far away from the public infrastructure, and require massive construction projects for their interconnection back to the existing grid. As a result, these installations are deployed far from the utility grid making which makes access of wind energy to homes or businesses very difficult. Finally, with a large wind turbine system an enormous investment is required. However, such investments have recently been viewed as a poor investment because they will simply not generate enough power when exposed to the constant changes in atmospheric wind conditions.

In contrast, small wind power systems are typically deployed in isolated areas. Such isolated deployments are therefore not useful in carrying out the direct powering of homes and business over large areas of land, or in establishing connection points to the utility grid.

In order to overcome the foregoing problems associated with the deployment of large and small wind turbine systems, others have contemplated deployment in existing locations, which maybe connected to supplement power to an existing power grid. One such example, disclosed in U.S. Pat. No. 7,525,210, to Fein et. al., is described for a roadway system of creating a networked infrastructure distribution platform of fixed wind gathering devices. There, the roadway system includes ground based wind energy turbines in combination with one or more roads and the roadway system electricity grid. The roadway system contemplates the conversion of wind conditions either generated by passing motor vehicles and the atmosphere. The turbines are connected to the roadway system electricity grid, and are positioned along the roads to in order to take advantage of the wind turbulence generated from the passing motor vehicles.

While the foregoing example offers some utility, a major disadvantage with this application lies in the fact that, while it does provide for an additional beneficial use of the existing roadway electrical grid, it continues in the past practice of requiring the construction of a network of wind turbine machines, together with all of their associated ground based supporting structures, and points of connection for installation along predetermined positions of the roadway. Therefore, such installations must be optimally engineered in turbine design, structure height, and investment potential in order to provide for the efficient use of wind energy from passing motor vehicles and atmospheric wind. Moreover, one must still analyze as a component of the system the overall environmental impacts associated its construction, operation, aesthetic appeal, and safety. Thus, it is desirable to provide a wind power energy system which is capable of ground-based deployment on the existing power grid infrastructure, but which also takes advantage of investment potential, is simple in design, installation, and use, and which is does not expand the existing environmental foot print. It is also desirable to provide a wind power energy system directly connected to the power grid infrastructure which is useful in the generation of electricity to both large and small energy utilities, homes and businesses. The present invention satisfies these needs.

### BRIEF SUMMARY OF THE INVENTION

It is therefore an object of the present invention to provide a wind power energy system capable of converting wind energy for transmission directly to the power grid.

It is another object of the present invention to provide a wind power energy system which deploys on existing ground-based electricity grid installations.

It is another object of the present invention to provide a wind power energy system which provides an attractive investment potential, is simple in design, deployment, and use, but which does not expand the environmental foot-print.

It is another object of the present invention to provide a wind power energy system which is capable deployment in retrofit applications on existing utility grid supporting structures.

It is yet another object of the present invention to provide an integrated large or small wind power infrastructure that is easily connected to multiple direct sources or various grid interconnection points.

To overcome the problems associated with the prior art methods, and in accordance with the purpose of the present invention, as embodied and broadly described herein, briefly a vertical axis wind system for generation and distribution of electrical energy to a utility grid is provided. The system includes a power pole electricity system supported by a plurality of ground-based upright support members. The electricity system is electrically connected to the utility grid. The support members include at least one vertical rotor shaft portion. The rotor shaft portion has an outer surface and a vertical axis of rotation. A vertical axis wind turbine is rotatably attached to the rotor shaft portion so that the wind turbine rotates freely around the outer surface of the rotor shaft portion. A power take-off, is coupled to the wind turbine for driving a generator electrically connected to the utility grid when exposed to an atmospheric wind condition.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention, and together with the description, explain the principles of the invention.

FIG. 1 shows is a perspective view of the present invention deployed in combination with a power pole.

FIG. 2 is a cross-sectional view of the present invention deployed on the power pole, as shown in FIG. 1.

FIG. 3 is a perspective view of the present invention showing deployment of a wind turbine array together with the associated generators on a plurality of power poles.

FIG. 4 is a perspective view of the present invention showing deployment of the wind turbine in a two generator configuration and deployed on a digital signal tower.

FIG. 5 is a cross sectional view of a preferred embodiment, shown in FIG. 4, showing the power takeoff having the drive gear driving two generator input shafts with the generators deployed in lateral alignment to the support members.

FIG. 6 is a perspective view of another embodiment of the present invention showing two upright support members attached to the ground based power pole, rotor shaft portions for affixing two vertical axis turbine assemblies where the generators are in axial alignment with the rotor shaft portions.

FIG. 7 is a perspective view of the present invention showing deployment of a wind turbine array, as configured in FIG. 6.

FIG. 8 is a perspective view of an embodiment of the present invention where the ground based power pole is a utility tower having two rotor shaft portions.

### DETAILED DESCRIPTION OF THE INVENTION

Unless specifically defined otherwise, all technical or scientific terms used herein have the same meaning as commonly understood by one of ordinary skill in the art to which this invention belongs.

A “wind turbine array” means a plurality of wind energy generating devices either on a network of power poles, or on a single power pole.

An “electricity system” means a ground based network of electrical connections for the transportation and transmission of electrical energy, and may, but need not, include, energy storage systems, controls for inverting energy, power source changing units, electricity meters, and backup power systems.

The “utility grid” or “grid” means, the existing infrastructure of electrical lines and power boxes, as further described below.

An “energy storage system” as used herein is any device that can store electrical energy including, without limitation, systems which transform electrical energy into some other form of energy such as chemical or thermal.

The term “power pole” means any upright member used in supporting a power pole electricity system including power poles, telephone poles, digital signal transmission towers, large scale electrical transmission towers, and signs.

Although any of the methods and materials similar or equivalent to those described herein can be used in the practice or deployment of the present invention, the preferred methods and materials are now described. Reference will now be made in detail to the presently preferred embodiments of the invention, examples of which are illustrated in the accompanying drawings wherein like numerals represent like features of the invention.

The invention provides a vertical axis wind system 10 for the generation, conversion and distribution of renewable wind energy into electrical energy to a utility grid. The system 10 is particularly useful in that it is suitable in retrofit deployment on an existing power pole 12 electricity infrastructure connected to the utility grid.

The grid is a power transmission network. The power grid is the bulk transfer of electric power to consumers. Multiple redundant lines between points on the network are connected so that power can be routed from any power plant to any load center. Transmission companies determine the maximum reliable capacity of each line, which, due to system stability considerations, may be less than the physical or thermal limit of the line. Thus, the d-c potential produced by the generator 24, in accordance with the present invention, is easily matched with the transmission companies' requirements.

A system which typically connects power plants to multiple substations near a populated area is called an electricity transmission system. The wiring from substations to customers is referred to as an electricity distribution utility grid or system. This system follows the well known business model separating the wholesale electricity transmission business from distributors which deliver the electricity to the homes. The utility grid allows distant energy sources (such as power plants) to be connected to consumers in population centers. Usually the transmission lines use alternating current or, as in the case of high voltage systems, direct current which is used for long distance transmission or undersea applications and in connecting different alternating current networks. The power is usually transmitted as alternating current through overhead power lines 15 supported on power poles or towers.

Power pole electricity systems including electrical power lines 15 and communication lines 11 have long been supported above ground by utility poles. Traditionally, utility poles are made from wood, steel, reinforced or prestressed concrete, or fiber reinforced composite materials, and may be formed as a solid or hollow member. The power poles are typically positioned within easements created for communications, railways, or roadways on a variety of terrains. Power poles typically include one or more substantially vertical upright structural support members 12 which, in accordance with the present invention, provide an existing portion for use as a rotor shaft 14 supporting the wind turbine 20 rotor assembly. The overall height of a typical tall power pole is an advantage, in use with the present invention, because both wind power and stack effect (for helical devices) will be increased with an increase in height. The upright support members 12 may be cylindrical, or square, shaped members and may be either solid, semi-solid, or hollow in construction. In addition, one or more upright support members 12 maybe attached in a substantially vertical orientation to an existing power pole or tower, having an inclined ground based supporting structure.

The upright support members 12 typically support “T” or “H” shaped members 17 for carrying the electrical power lines 15. The system 10 includes a power pole electricity system having a plurality of ground based upright support members 12 electrically connected to the utility grid. At least one of the support members 12 is configured to include at least one elongated substantially vertical rotor shaft portion 14. The rotor shaft portion 14 has an outer surface and a vertical axis of rotation.

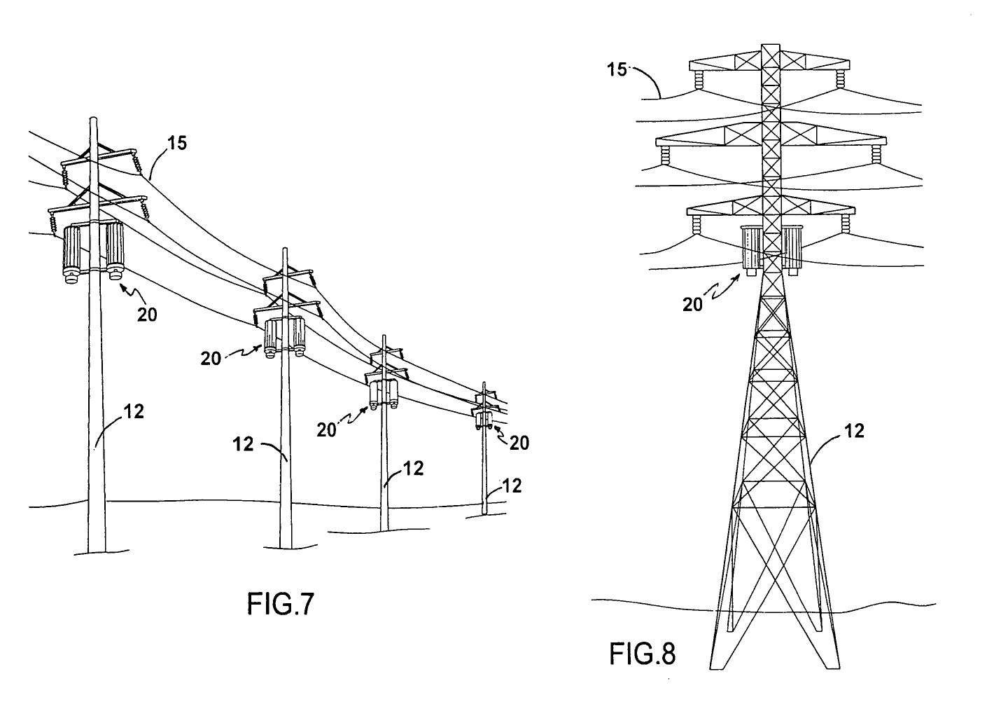

Vertical axis turbines 20 rotate around the vertical axis, which is oriented, as in the present invention, more or less, perpendicular to the ground. The present invention contemplates the use of any type of vertical axis turbine 20 assembly, well known in the art, including such devices known as a Darrieus wind turbine, a Giromill-type Darrieus wind turbine, a Savonius wind turbine, a helix-style turbine, and the like. The wind turbine 20 is desirably deployed at any height which is desirable taking into consideration the existing dimensions of the upright support members together with other variables relating to the desired use, output potential, environmental impact, or terrain. The wind turbines 20 can be spatially oriented in arrays, as illustrated in FIGS. 3 and 7, for any distribution that conforms with the requirements of transmissions companies, electrical storage, output, safety and other municipal and governmental regulations.

As shown in the drawing figures, and in accordance with the present invention, the wind turbines 20 are rotatably connected to the rotor shaft portion 14 of the upright support member 12 by any conventional mechanical, or other suitable, methods such as clamping, bolting or welding. The vertical axis wind turbine 20 desirably includes two rotor assemblies, preferably including bearing assemblies 16 to rotatably mount to the rotor shaft portion 14 of the power pole 12. The rotor assemblies are affixed to the upright support member rotor shaft portions 14 either directly or indirectly, such as, when the wind turbine 20 includes upper and lower plates connecting the bearing assemblies 16 to the rotor shaft portion 14 of the power pole support member 12. As such, the rotor assembly may, but need not, include a circular bottom plate, a circular top plate, with the vanes 19 disposed circumferentially between the bottom and top plates. The rotor assembly rotates about the rotor shaft portion 14 when exposed to an atmospheric wind condition.

A power takeoff assembly 21, 22 is provided. It desirably includes a gear driven configuration 21, 22, but may also be configured in a pulley or magnetic drive construction, of any type well known in the art. In the illustrated embodiments, according to FIGS. 2 and 5, the drive gear 21 is rotatably engaged to the rotor assembly of the wind turbine 20 so that the rotor assembly and the drive gear 21 rotate as a single unit. The rotor assembly is supported on the rotor shaft portion 14 by an upper and lower bearing assemblies (located generally at 16). Bearing assemblies located at 16 facilitate the a rotor assembly to be rotatably mounted around the rotor shaft portion 14 and are of any design well known to one skilled in the art to include a plurality of bearing balls contained in bearing races (not shown).

A plurality of wind vanes 19 are disposed in circumferential alignment about the rotor shaft 14 of the power pole support member 12. As shown in drawing figures, FIGS. 6, 7, and 8, a plurality of wind turbine 20 rotor assemblies may be mounted on a single power pole support 12 to provide additional electrical power to the utility grid, per pole.

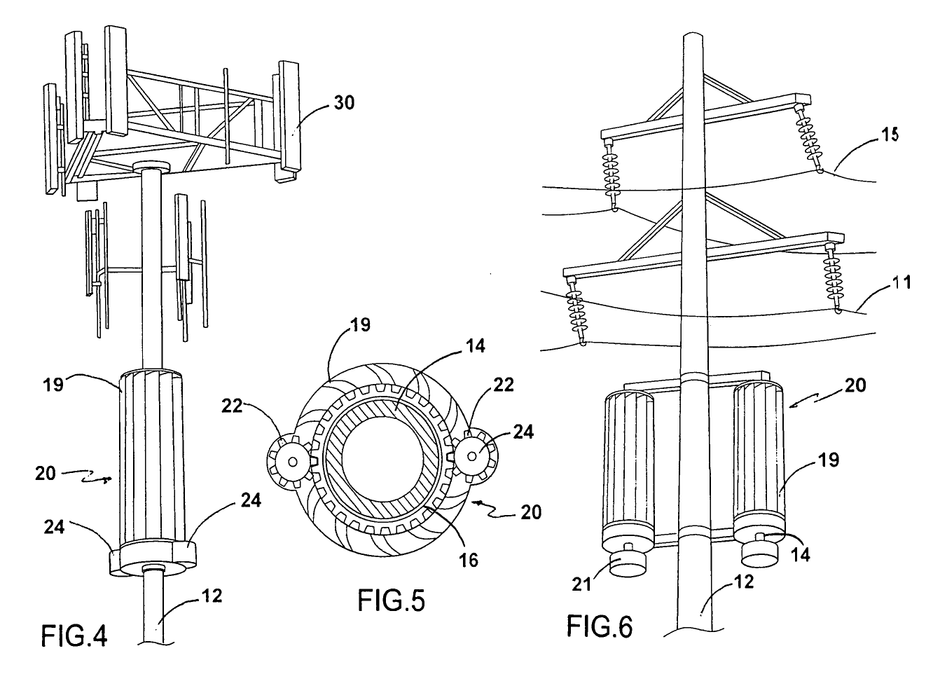

The generator 24 is of any type well known in the art which produces d-c potential, including generators and rotating electrical machines. More than one generator 24 may be deployed in engagement with the power take off 21, 22 from a single wind turbine 20, as illustrated in FIGS. 4 and 5, on a digital transmission tower 30. The generator 24 is desirably connected with output leads (not shown) either to the power pole electricity system, the utility grid, or an energy storage system connected to the utility grid. As above, the overall construction of the generator 24, power takeoff 21, 22, and wind turbine 20 is dependant upon a variety of variables associated with the construction of electrical rotating machines according to standards within the industry.

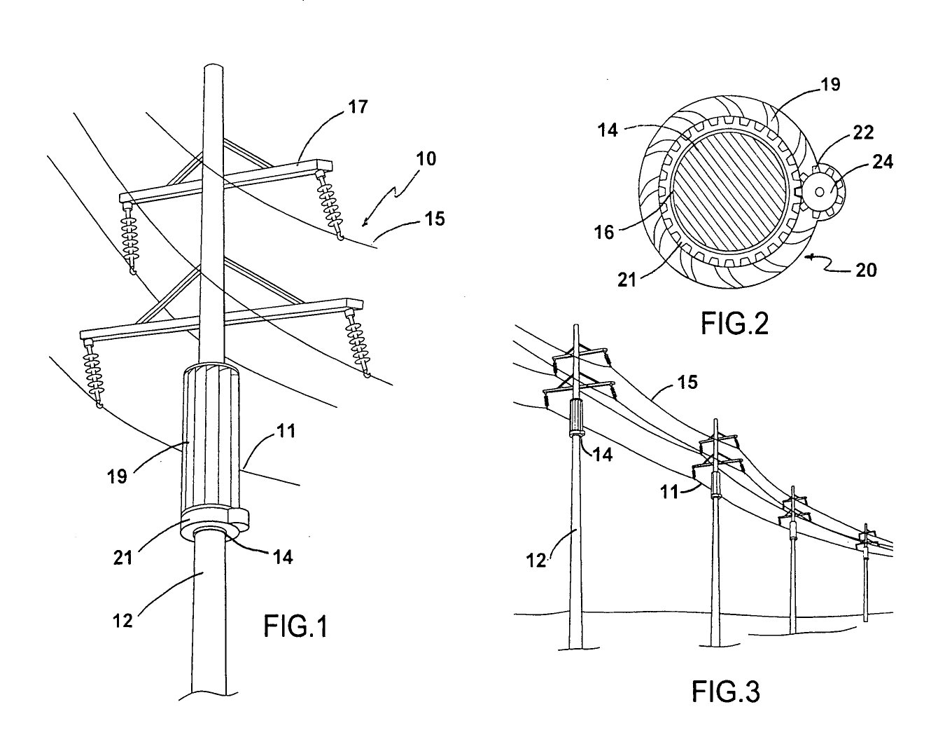

With deployment, as illustrated in FIGS. 1, and 2, in its simplest embodiment, which is highly useful in a retrofit application, a power pole support 12 is provided which includes electricity lines 15 connected to the grid. The power pole ground-based upright support members 12 provide the desired location for at least one substantially vertical rotor shaft portion 14 having an outer surface and a vertical axis of rotation for attachment of the wind turbine 20, power takeoff 21, 22, and generator 24 assemblies. In a preferred embodiment, the wind turbine 20, power takeoff 21, 22, and generator 24 devices are designed, constructed, and shipped as a single functional unit for attachment and electrical connection, on-site, to the power pole support 12 at any desired predetermined position for the pole support 12 to function as the rotor shaft 14.

Mounting the vertical axis wind turbine 20 rotor assembly to the rotor shaft 14 portion of the power pole support 12 may be made by attaching the bearing assemblies directly to the rotor shaft portion 14, or with the use of upper and lower mounting brackets or plates which either house or connect to the bearing assemblies, in any such manner which is well known, so long as the wind turbine 20 rotor assembly rotates freely around the outer surface of the rotor shaft portion 14 when the vanes 19 are exposed to an atmospheric wind condition.

The power takeoff assembly 21, 22, the bearing assembly, positioned at 16, and the generator 24 are preferably contained within a common housing configured to receive the assemblies in workable engagement with one another, and to protect the assembled configuration from harsh atmospheric conditions. The generator 24 is finally connected, via output leads, or in any other manner, to the utility grid via the electricity system or electrical storage devices.

In use, cross winds impinge upon the wind vanes of the rotor assembly to produce rotation of the rotor assembly, in relation to the rotor shaft 14 portion. The power takeoff 21, 22, concurrently engages the generator 24 which generates electricity to the power pole electricity system, electricity storage system, or both, which, in turn distribute energy directly to the utility grid.

As shown in FIGS. 3 and 7, the present invention is preferably deployed on a network of power poles 12 as an array of wind turbines 20. Moreover, as shown in FIG. 5, the power takeoff 21, 22 may be used to drive more than one generator 24 per wind turbine 20. Finally, and as specifically contemplated herein, the rotor shaft portion 14 may be an attachment to an existing power pole or tower structure so as to support more than one wind turbine 20 in lateral alignment, or in axial alignment as one on top of the other (not shown).

While the present invention has been described in connection with the embodiments as described and illustrated above, it will be appreciated and understood by one of ordinary skill in the art that modifications may be made to the present invention without departing from the true spirit and scope of the invention, as broadly described and claimed herein.

I claim:

1. A vertical axis wind system for generation and distribution of electrical energy to a utility grid, comprising:
(a) a power pole electricity system supported by a plurality of ground based upright support members, the electricity system electrically connected to the utility grid, at least one of the support members configured to include at least one substantially vertical rotor shaft portion having an outer surface and a vertical axis of rotation;
(b) at least one vertical axis wind turbine having a rotor assembly including a plurality of wind vanes rotatably connected to the rotor shaft so that the wind turbine rotor assembly rotates freely around the outer surface of the rotor shaft when exposed to an atmospheric wind condition;
(c) a power takeoff assembly coupled to the wind turbine having a drive member and a driven member;
(d) a generator driven by the power takeoff; and
(e) a point of connection wherein the generator is electrically connected to the utility grid.

2. The vertical axis wind system according to claim 1, wherein the upright support member is a utility power pole, a telephone pole, a digital signal receiver, or a sign.

3. The vertical axis wind system according to claim 1, wherein the drive and driven members include gears, magnets, or pulleys.

4. The vertical axis wind system according to claim 1, wherein the wind turbine rotor assembly is rotatably connected to the rotor shaft portion with a bearing assembly.

5. The vertical axis wind system according to claim 1, wherein the generator is aligned parallel and lateral to the rotation axis.

6. The vertical axis wind system according to claim 2, wherein the power pole support member includes at least two rotor shaft portions for receiving at least two wind turbine rotor assemblies.

7. The vertical axis wind system according to claim 4, wherein the bearing assembly includes bearing balls and races.

8. In combination, with a power pole electricity system supported by a plurality of ground-based upright support members, the electricity system electrically connected to the utility grid, and at least one of the support members configured to include at least one substantially vertical rotor shaft portion having an outer surface and a vertical axis of rotation, the improvement, comprising:
(a) at least one vertical axis wind turbine having a rotor assembly including a plurality of wind vanes rotatably connected to the rotor shaft so that the wind turbine rotor assembly rotates freely around the outer surface of the rotor shaft portion when exposed to an atmospheric wind condition;
(b) a power takeoff assembly coupled to the wind turbine having a drive member and a driven member;
(c) a generator driven by the power takeoff assembly; and
(d) a point of connection wherein the generator device is electrically connected to the utility grid.

9. A method for generation and distribution of electrical energy to a utility grid, comprising:
(a) providing a power pole electricity system supported by a plurality of ground-based upright support members, the electricity system electrically connected to the utility grid, at least one of the support members configured to include at least one substantially vertical rotor shaft portion having an outer surface and a vertical axis of rotation;
(b) mounting at least one vertical axis wind turbine having a rotor assembly including a plurality of wind vanes rotatably connected to the rotor shaft so that the wind turbine rotor assembly rotates freely around the outer surface of the rotor shaft portion when exposed to an atmospheric wind condition;
(c) coupling a power takeoff assembly to the wind turbine rotor assembly having a drive member and a driven member;
(d) connecting the generator to the power pole electricity system; and
(e) rotating the wind turbine rotor assembly in relation to the power pole rotor shaft member so that the power takeoff drives the generator to produce electrical energy to the utility grid.
